(19) United States
(12) Patent Application Publication
(10) Pub. No.: US 2018/0165772 A1
(43) Pub. Date: Jun. 14, 2018

(54) TIERED GREENING FOR LARGE BUSINESS OPERATIONS WITH HEAVY POWER RELIANCE

(71) Applicant: Palo Alto Research Center Incorporated, Palo Alto, CA (US)

(72) Inventors: Lara S. Crawford, Belmont, CA (US); Daniel H. Greene, Sunnyvale, CA (US)

(73) Assignee: Palo Alto Research Center Incorporated, Palo Alto, CA (US)

(21) Appl. No.: 15/379,330

(22) Filed: Dec. 14, 2016

(51) Int. Cl. G06Q 50/06; G06Q 30/02

(52) U.S. Cl. CPC G06Q 50/06; G06F 1/32; G06Q 30/0202

(57) ABSTRACT

Embodiments of the present invention provide a system for tiered greening of power consumption on shared equipment. The system improves significantly over previous systems by allowing large organizations to utilize renewable (“green”) power progressively, fulfilling customer stipulations of power quantity, quality, and delivery, and apportioning the cost fairly among customers. During operation, the system obtains a plurality of Service Level Agreements (SLAs) detailing power consumption by a plurality of jobs from a plurality of customers, wherein the SLAs specify a level of green power generated from renewable sources, and green power quality and delivery requirements. The system then apportions the power consumption to a respective job, in satisfaction of the job's SLA, yielding a net increase in a total level of green power of the plurality of jobs. The system may then control the shared equipment to execute the job according to the apportioned power consumption.

### BACKGROUND

### Field

The present disclosure relates to renewable (“green”) power. More specifically, this disclosure relates to a method and system for tiered greening of power consumption on shared equipment, fulfilling customer stipulations and apportioning power costs among customers.

### Related Art

Large operations with many customers and high power consumption, such as data centers, job shops, print shops, etc., may be interested in becoming more environmentally sustainable, or “greener,” for both altruistic and regulatory reasons (e.g., regulatory carbon caps, etc.). This demand for “greening” may also be driven by customers, and could even be an important aspect of the operation's competitiveness and/or ability to market to such eco-conscious customers. These customers may wish to stipulate green business practices or considerations in binding documents, such as Service Level Agreements (SLAs). Accordingly, businesses or organizations may wish to adopt “green” or renewable energy or power from sources such as wind, solar energy, hydropower, geothermal energy, or biofuel. However, it may be prohibitively expensive or difficult for a large operation to completely overhaul its power use.

For example, a type of business that could benefit from a progressive, partial, or “tiered” approach to greening is data centers. Large corporations operating multiple data centers can afford investments to green entire data centers with technology (e.g. Facebook's evaporative cooling) or with power purchase agreements (e.g. Google's offsetting power purchase agreements to fund renewables elsewhere in the country). However, not all data centers have these options. Thus, there is need for a method through which such data centers can partially green their operations in a graduated way, offering greener operations to customers who are interested and making progress towards improving the carbon profile of their operation. A key to doing so is accountability, that is, accounting for and tracking power use among all jobs, in order to verify that power consumption is greened in accordance with the SLA.

### SUMMARY

One embodiment of the present invention provides a system and method for tiered greening of power consumption on shared equipment. During operation, the system obtains a plurality of Service Level Agreements (SLAs) detailing power consumption by a plurality of jobs from a plurality of customers, wherein the SLAs specify a level of green power generated from renewable sources, and green power quality and delivery requirements. The system then apportions the power consumption to a respective job, in satisfaction of the job's SLA, yielding a net increase in a total level of green power of the plurality of jobs. The system may then control the shared equipment to execute the job according to the apportioned power consumption.

In a variation on this embodiment, apportioning the power consumption to the respective job further comprises apportioning an overhead power consumption.

In a variation on this embodiment, apportioning the power consumption to the respective job further comprises estimating a total power consumption, including the overhead power consumption, needed to satisfy the plurality of SLAs, including a quality specification. The system may then estimate a quantity of green power needed to satisfy the respective SLA, including satisfying the level of green power and the green power quality and delivery requirements specified by the SLAs. The system may then estimate, based on the total power consumption and the quantity of green power, a quantity of other power needed to execute the job in satisfaction of the respective SLA.

In a variation on this embodiment, apportioning the power consumption to the respective job further comprises: determining a cost associated with the estimated quantity of green power and quantity of other power; and associating the determined cost with a customer to whom the respective job belongs.

In a variation on this embodiment, determining the cost involves one or more of: computing the cost as a Shapley value; computing a core-based solution for the cost; and applying a nucleolus method.

In a variation on this embodiment, apportioning the power consumption to the respective job further comprises predicting a total quantity of green power needed to satisfy the plurality of SLAs, including the level of green power specified by the SLAs, during a future time interval. The system may then purchase green power, based on the predicted total quantity, via one or more of: an advance power market; a spot power market; a price purchase agreement (PPA); and a commercial power agreement specifying a number of blocks of green power of a predetermined size.

In a variation on this embodiment, the respective SLA specifies one or more of: a proportion of green power to be used in the job; a proportion of green power to be used over a time period in the job; a quantity of green power to be used in the job; a type of green power to be used in the job; a source of green power to be used in the job; a timing of green power to be used in the job; a response time associated with the job; and a speed associated with the job.

In a variation on this embodiment, the plurality of jobs include one or more of: data center computations; manufacturing services; job shop services; print shop jobs; food preparation; product packaging; hotel or hospitality services; and recreational or entertainment services.

### BRIEF DESCRIPTION OF THE FIGURES

FIG. 1 schematically illustrates a probabilistic interpretation of tiered requirements for green power consumption.

FIG. 2 presents a block diagram illustrating an exemplary tiered greening system utilizing the power apportioning method, according to embodiments of the present invention.

FIG. 3 presents a block diagram illustrating a method for tiered greening of power consumption, according to embodiments of the present invention.

FIG. 4 presents a block diagram illustrating a method for apportioning power consumption on shared equipment, according to embodiments of the present invention.

FIG. 5 presents a block diagram illustrating an exemplary apparatus for tiered greening of power consumption on shared equipment, in accordance with embodiments of the present invention.

FIG. 6 presents a block diagram illustrating an exemplary computer system for tiered greening of power consumption on shared equipment, in accordance with embodiments of the present invention.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention solve the problem of tiered greening of power consumption on shared equipment by predicting, accounting for, and tracking green power use and the associated costs among a set of jobs. The system can improve on previous systems by allowing large organizations to utilize renewable (“green”) power or energy progressively or gradually. In some cases, this demand for “greening” may be driven by customers, and could even be an important aspect of the operation's competitiveness and/or ability to market to such eco-conscious customers. Thus, the system further improves on previous systems by fulfilling customer Service Level Agreements (SLAs) stipulating power quantity, quality, and delivery requirements, and apportioning associated costs fairly among customers. During operation, the system obtains a plurality of SLAs detailing power consumption by a plurality of jobs from a plurality of customers, wherein the SLAs specify a level of green power generated from renewable sources, and green power quality and delivery requirements. The system then apportions the power consumption to a respective job, in satisfaction of the job's SLA, yielding a net increase in a total level of green power of the plurality of jobs. The system may then control the shared equipment to execute the job according to the apportioned power consumption.

The approach to partial greening disclosed herein enables large operations whose services depend heavily on power to adopt green power gradually, by using partly green and partly conventional (or “brown”) power. Using the disclosed methods and system, a large operation can manage power purchases and business operations to meet individual customers' green power requirements. The system can define different levels, or “tiers,” of green power, and customers can choose among these levels and stipulate them in binding documents, such as Service Level Agreements (SLAs) or other agreements. The system further apportions costs associated with green and brown power, thus enabling the organization to choose how much extra cost associated with each tier of greening to pass on to the customers, in a manner consistent with the customers' choices.

Consequently, a key to tiered greening and cost apportioning is accountability, i.e., the system's ability to account for and track power use among jobs, in order to verify that power consumption is greened in accordance with an SLA. For example, an SLA might stipulate 50% or 95% of a customer's power from green sources, for example, depending on the chosen green level. Or a customer might choose a very “highly green” power tier, guaranteeing that 99% of power used to serve the customer's needs is produced from green sources. The system may apportion higher fees to customers choosing higher green levels. Different types of SLAs or other agreements are possible to specify this requirement, using different criteria. For example, a level of 99% green power might be stipulated as an ongoing minimum over time, or simply as an average over the course of a month, therefore allowing several hours at once when only brown power is supplied.

The disclosed system and methods can manage power and operations and verify that any of these types of SLA or agreement for green power consumption are met Likewise, the system may address costs associated with the power purchased or consumed. The structure of such costs may depend on the type of power arrangements and/or pricing arrangements used, as will be discussed in further detail below. Accordingly, there are four important considerations relevant for tiered greening accountability: modeling the power purchase system and associated costs; dispatch, or deciding how much power to purchase and in what manner; scheduling and operation of equipment; and allocating the costs among customers. Each of these will be described further below.

Therefore, the disclosed system and methods are largely concerned with accountability. Specifically, an important aspect of accountability is the system's ability to determine how overhead or fixed costs (e.g., power consumption by idle machines) should be accounted for, either for past jobs or future predictions. This disclosure will use the terms apportioning and allocating to refer to such determinations, both in the case of power consumption, and of costs associated with power consumption. Additionally, these terms might refer either to predicting future costs or consumption, or to assigning actual past or present costs/consumption to completed or current jobs, such as for billing purposes. (Moreover, these estimates might be broken down by jobs, or by customers, and could refer to green or brown power consumption, or total consumption).

Usually, the system will use predictive apportioning of future power consumption, for the general purpose of making purchasing decisions (i.e., dispatch) for green power, brown power, and/or total power, and for scheduling and operation of equipment. The system will usually use actual apportioning on costs associated with past jobs, for the purposes of accounting or billing customers fairly. However, in some embodiments, other variations are possible. For example, the system may use actual apportioning on past power usage instead of costs. Or the system may use predictive apportioning on costs for the purpose of taking costs into account in purchase decisions.

### Probabilistic Interpretation of Dispatch for Tiered Greening

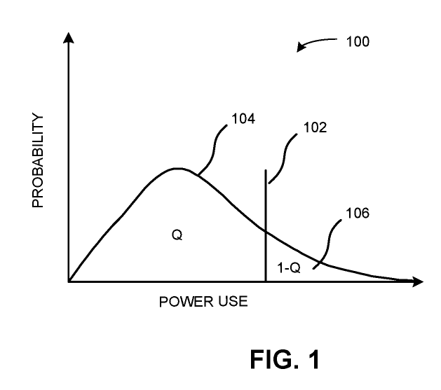

FIG. 1 schematically illustrates a probabilistic interpretation 100 of tiered requirements for green power consumption. We assume that there are two potential sources of power, which supply quantities p_{g} of green power and p_{b} of brown power, respectively. In some embodiments, the system may require that these sum to a total quantity of consumed power, p_{g}(t)+p_{b}(t)=p(t). In a tiered green offering, the organization might guarantee to a customer that a minimum level pᵢ of power use is provided for job i from green sources. For example, an SLA may stipulate a given green percentage level Q, and the system may obtain an estimated probability distribution (shown as probability density function 100) of power use by the customer at a time t. In some embodiments, the green percentage level Q may be related to power use as p_{g}(t)/p(t), or as pᵢ divided by a total estimated power use for job i. In some embodiments, the system implements the SLA's green level mathematically by requiring that sufficient green power p_{g}(t) be purchased such that a cumulative probability Q lies below p_{g}(t). As shown in FIG. 1, this is equivalent to requiring that a proportion Q of the area under the probability density function 100 lies below p_{g}(t).

The operation of obtaining the power level 102 below which proportion Q (item 104) of the estimated distribution lies will be referred to as \tilde{p}(t|t−d)_{Q}, and is equivalent to evaluating an inverse of the cumulative probability distribution. Here d may refer to an amount of time in advance of t at which the green power usage is predicted. Likewise, a prediction made at time t−d of the total power usage (including green and brown power) at time t will be denoted as \tilde{p}(t|t−d), and the subscript i may refer to a prediction for a given job i. For example, in a data center, the system may model the power consumption of N computational nodes as \tilde{p}=aN+b Σᵢ^{N}\tilde{x}ᵢ, where a represents an overhead power usage per node, and \tilde{x}ᵢ represents a predicted computational load of node i.

Based on the estimated probability distribution 100, p(t) has a probability of Q to lie below \tilde{p}(t|t−d)_{Q}. Therefore, the expected proportion of green power (based on the estimated probability distribution) is given by

$${\int }_{0}^{∞} ρ ( \overline{P} ) min ( \frac{\tilde{p}}{p} , 1 ) d \overline{P} = Q + {\int }_{\tilde{p}}^{∞} ρ ( \overline{P} ) \frac{\tilde{p}}{\overline{p}} d \overline{P} \geq Q ,$$

where ρ is the probability density function 100. That is, sufficient green power should be purchased to fully cover the total power usage a fraction Q of the time. Even if total power usage p(t) exceeds \tilde{p}(t|t−d)_{Q} (i.e., lies in region 106), the purchased green power will still partially cover power usage. In some embodiments, an expected proportion higher than Q is desirable, in order to safeguard against uncertainty in the estimated probability distribution. In some embodiments, the system may instead quantitatively determine \tilde{p}(t|t−d)_{Q} such that the expected proportion equals Q, assuming the estimated probability distribution to be correct. In some embodiments, the system may simply purchase green power based on a straightforward amount such as pᵢ stipulated by the SLA.

### System Architecture

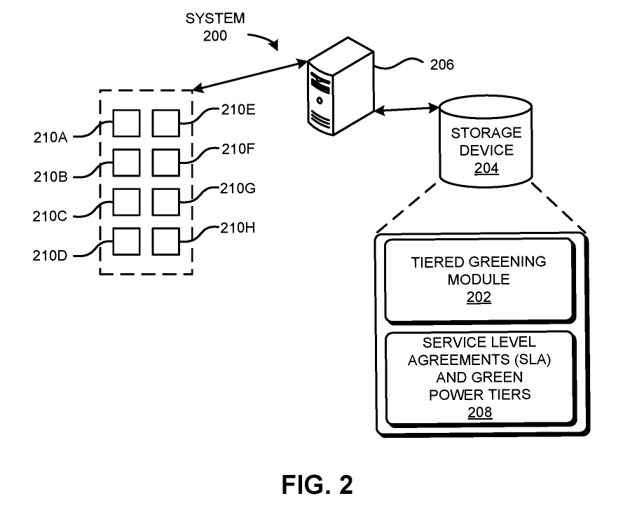

FIG. 2 presents a block diagram illustrating an exemplary tiered greening system utilizing the power apportioning method, according to embodiments of the present invention. A tiered greening system 200 may distribute SLA requirements or other data among processors and apportion power, according to embodiments, in parallel with multiple processors. Using standard systems, a large organization may incur significant costs to completely overhaul its power use. Using the methods disclosed herein, system 200 allows large organizations to utilize renewable (“green”) power progressively, fulfilling customer stipulations of power quantity, quality, and delivery, and apportioning the cost fairly among customers.

Tiered greening system 200 may include a tiered greening module 202 installed on a storage device 204 coupled to a server 206. Note that various implementations of the present invention may include any number of computers, servers, and storage devices. In various implementations, tiered greening module 202 may include a green power quantity estimating module or other components of tiered greening system 200 to perform the techniques described herein. System 200 may receive data describing a Service Level Agreement (SLA), power consumption, or costs, and store such data in storage device 204. System 200 may read the code for tiered greening module 202 and the data for SLAs and green power tiers 208 from storage device 204. System 200 may distribute SLA requirements and/or green power tiers or requirements among processors, such as processors 210A-210H, which operate on the assigned SLA requirements and/or green power tiers or requirements.

### Method for Tiered Greening of Power Consumption

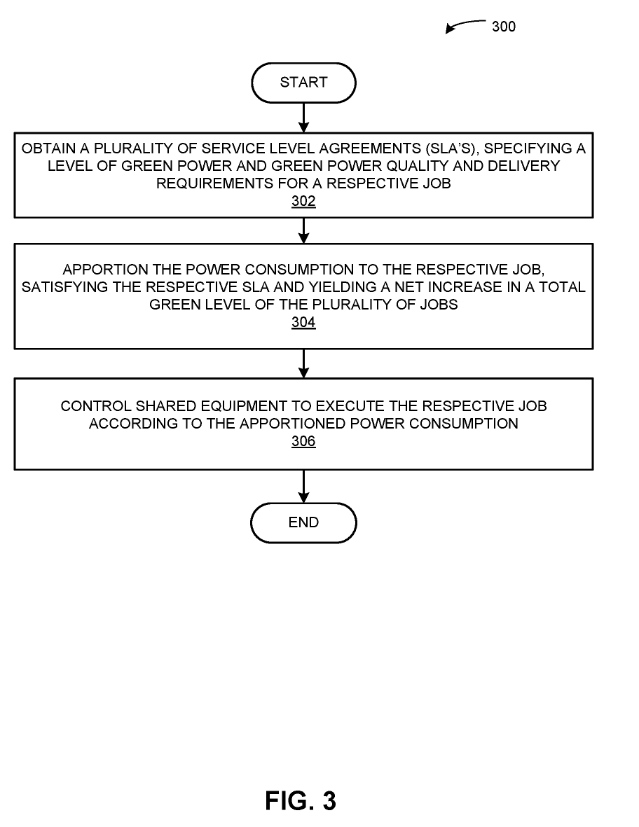

FIG. 3 presents a block diagram illustrating a method 300 for tiered greening of power consumption, according to embodiments of the present invention. During operation, the system obtains a plurality of Service Level Agreements (SLAs), specifying a level of green power and green power quality and delivery requirements for a respective job in a plurality of jobs to be performed on shared equipment (operation 302). The plurality of jobs may include data center computations, manufacturing, job shop services, print shop jobs, food preparation, product packaging, hotel or hospitality services, or recreational or entertainment services. In some embodiments, the system may receive other forms of agreements or customer requests.

Note that, in some embodiments, the SLAs and/or the specified green power level and green power quality and delivery requirements may differ among the plurality of jobs. That is, individual jobs, customers, and/or SLAs may specify their own requirements, independently of those specified by the others. The SLAs may specify the level of green power and green power quality and delivery requirements for each individual job, or for all or a subset of a customer's jobs. The level of green power may also be referred to as a tier, and may include a quantity of green power, a percentage or proportion of green power, a percentage or proportion of jobs to be performed with green power, or a minimum or range. The level of green power may be stipulated as an ongoing minimum over time, or as an average over a time period, such as a month. In some embodiments, the system may use another statistic to specify the level of green power, such as a median, or range.

In some embodiments, the green power quality and delivery requirements may include any stipulations about the quality and/or delivery of green power. For example, in some embodiments, the SLA may specify responsiveness requirements, either for jobs performed with green power, or in general. For example, responsiveness requirements could include a response time or speed for job initiation or completion. Green power quality requirements could also include environmental attributes, such as a level of environmental or sustainability certification for green power. Likewise, green power quality and delivery requirements could include a source or source type for green power. For example, the requirements could stipulate that green power is generated by wind, solar energy, hydropower, geothermal energy, ocean currents, or biofuel/bio energy, or could specify a particular provider or plan of green power. In some embodiments, green power quality and delivery requirements could include a timing associated with green power to be used in the job. For example, the requirements could state a number of hours of green power to be used, or that green power must be used during peak or off-peak demand times, or that response times must be low during certain times of day. In some embodiments, the SLA could also specify that the green power level represents a net increase in usage of green power across all jobs, i.e. that green power allocated to, or purchased on behalf of, the customer not be offset by brown power usage elsewhere. Such a net increase may be above a baseline level of green power already present in the standard commercial power.

The system may then apportion or allocate the power consumption to the respective job, satisfying the respective job's SLA (operation 304). That is, the system may estimate an amount of power consumption that can be attributed to the respective job, and schedule machinery to operate the job. When there are a plurality of jobs, an excess of green power purchased to meet stochastic requirements (as in FIG. 1) may be beneficially allocated to other jobs. In some embodiments, operation 304 may yield a net increase in a total green level of the plurality of jobs. This total green level may be quantified in terms of a proportion from green sources of total power consumed, in terms of a decreasing function of a total quantity of brown power consumed, or of other measures of environmental sustainability known in the art.

Apportioning the power consumption to the respective job may involve predicting a future consumption by the job, and/or estimating how much consumption is directly or indirectly attributable to the job. In some embodiments, apportioning the power consumption to the respective job involves apportioning an overhead power consumption. For example, in a data center, the overhead power consumption may be used to run computers that are partially idle. Such overhead consumption may be related to the power quality and/or responsiveness requirements. For example, some computing jobs may be batch jobs that could run any time, while others may be interactive jobs requiring computations with very low latency. A faster response time or speed may require more idle computers to be powered, so they can respond immediately when jobs appear. In some embodiments, the system may apportion such overhead power consumption proportionally to the overall apportioning of power consumption. In some embodiments, the system may use more sophisticated apportioning such as Shapley values, based, e.g., on the power quality or responsiveness requirements.

In some embodiments, apportioning the power consumption to the respective job may involve predicting a total quantity of green power that will be needed during a future time interval to satisfy the plurality of SLAs. This prediction or estimate may be based on the levels of green power specified in respective SLAs, as will be discussed further below. The system may then purchase green power, based on the predicted total quantity. The system may purchase green power via an advance power market, a spot power market, a price purchase agreement (PPA), and a commercial power agreement specifying a number of blocks of green power of a predetermined size.

The system may then control the shared equipment to execute the respective job according to the apportioned power consumption (operation 306). The shared equipment may include equipment used by a business, organization, or other provider to perform a plurality of jobs for a plurality of customers, i.e. it may be shared among multiple customers. In some embodiments, the equipment may be shared according to a schedule (e.g., it may be guaranteed to a particular customer for a predetermined period of time, or it may be leased during particular time interval). In some embodiments, the equipment may instead be shared according to job requirements, e.g. the provider may determine how to share the equipment in order to complete jobs and/or satisfy SLAs. The shared equipment may include servers or other computers, industrial or factory machinery, vehicles, printing equipment, kitchen or food preparation equipment, product packaging, agricultural equipment, recreational equipment, or any equipment used to provide services or execute jobs for multiple customers. In some embodiments, the system may directly control the shared equipment, or may control the equipment via a controlling apparatus, optimization agent, or computer, or return or output a control plan for a user or networked device. The system may move jobs to different times or machines to reflect power prices and/or green power availability, and may track the power mix and the individual power use.

### Method for Apportioning Power Consumption

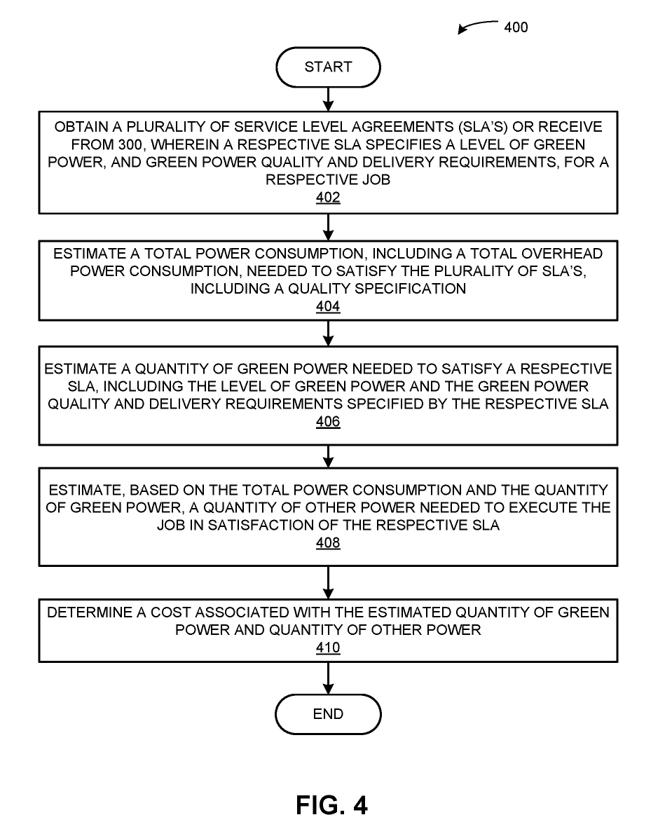

Apportioning or allocating power consumption to a respective job may involve predicting a future consumption by the job, and/or estimating how much consumption is directly or indirectly attributable to the job. FIG. 4 presents a block diagram illustrating a method 400 for apportioning power consumption on shared equipment, according to embodiments of the present invention. During operation, the system obtains a plurality of Service Level Agreements (SLAs), specifying a level of green power and green power quality and delivery requirements for a respective job in a plurality of jobs to be performed on shared equipment (operation 402). Alternatively, in step 402, the system may receive the SLAs from method 300. In some embodiments, individual jobs, customers, and/or SLAs among the plurality of SLAs may specify their own level of green power and green power quality and delivery requirements, independently of those specified by the others.

The system may then estimate a total power consumption needed to satisfy the plurality of SLAs (operation 404). In some embodiments, the total power consumption is a sum of power consumption over the plurality of jobs. In some embodiments, this estimate may be based on a quality specification in the plurality of SLAs. In particular, in some embodiments, the total power consumption includes a total overhead power consumption. Such overhead consumption may be associated with equipment maintained in an idle state, so as to satisfy power quality and/or responsiveness requirements. For example, in a data center, the overhead power consumption may maintain more computers powered on but partially idle than the number needed to run existing jobs, thereby improving the data center's speed or ability to respond to new jobs. The overhead power can also correspond to a fixed cost, such as power consumption by a piece of equipment independent of the equipment's utilization level. For example, for servers or other computers in a data center, the system may model the power consumption of N powered nodes as p=aN+b Σᵢ^{N} xᵢ, where a represents an overhead power usage per node, and xᵢ represents the computational load of node i.

Note that the methods and system disclosed herein may enable a large operation to save resources by bundling jobs together in order to purchase green power in bulk or at wholesale rates. Furthermore, this may be thought of as a wholesale approach. In this regard, the system may therefore predict power demand in step 404, just as a wholesale business would do.

The system may then estimate a quantity of green power needed to satisfy a respective SLA, including the level of green power and the green power quality and delivery requirements specified by the respective SLA (operation 406). For example, if the level of green power in the SLA stipulates a given green percentage level Q, the system may multiply Q by an estimated total power usage of the job, or might determine \tilde{p}(t|t−d)_{Q}, as described previously.

The system may then estimate, based on the total power consumption and the estimated quantity of green power, a quantity of other power (i.e., conventional or “brown” power) needed to execute the job in satisfaction of the respective SLA (operation 408). In some embodiments, the system may simply relate the quantity of other power to the estimated total power consumption minus the estimated quantity of green power. In some embodiments, the system may compute a total estimated quantity of green power as a sum of quantities of green power for respective jobs in the plurality of jobs. The system may then relate the quantity of other power to the estimated total power consumption minus the estimated total quantity of green power.

The system may then determine a cost associated with the estimated quantity of green power and quantity of other power (operation 410). As mentioned previously, there are four important considerations for tiered greening accountability: modeling the power purchase system and associated costs; dispatch, or deciding how much power to purchase and in what manner; scheduling and operation of equipment; and allocating the costs among customers. In various embodiments, operation 410 involves allocating the costs among customers, which may involve computing the cost as a Shapley value, computing a core-based solution for the cost, or applying a nucleolus method. These three important considerations will be discussed further below.

### Accountability, Data Center Example, and Applications

An important domain of the disclosed system is greening data centers. This discussion focuses on data centers, but may also be applicable to any provider performing jobs for a plurality of customers on shared equipment. By participating in power markets over different time scales (such as day-ahead, hour-ahead, and spot, for example), a data center may be able to purchase green and brown power at wholesale rates. The amount of green power purchased in market j, held at time t−dⱼ to purchase power for time t, will be denoted as gⱼ(t|t−dⱼ), and likewise brown power as bⱼ(t|t−dⱼ). For example, for the day-ahead market, dⱼ would be one day. Then the total quantity of each type of power is the sum of purchases over all the markets: p_{g}(t)=Σⱼgⱼ(t|t−dⱼ), p_{b}(t)=Σⱼ bⱼ(t|t−dⱼ).

The SLA requirements demand that enough green power be purchased to meet the needs of all the customers: p_{g}(t)≥Σᵢ\tilde{p}ᵢ(t)_{Q}_{ᵢ}. The cost of the power purchased depends on the market, and on the type of green or brown power. The costs associated with gⱼ(t|t−dⱼ) and bⱼ(t|t−dⱼ) will be denoted by c_{gi}(t|t−dⱼ) and c_{bj}(t|t−dⱼ), respectively. The total cost for all power purchased is then given by the sum of these, Σⱼc_{gj}+c_{bj}. The later markets are typically more expensive, but power need estimates may be more accurate, since the system can make purchase decisions closer to actual consumption, thereby limiting penalties for over- or under-purchase.

In various embodiments, the system may use different methods to decide how much power to purchase in each market, and may estimate and apportion costs based on modeling these markets. Apportioning or allocating costs may involve predicting a future cost of power used by a respective job, and/or estimating how much cost is directly or indirectly attributable to the job. In various embodiments, the system may purchase a large quantity in the earliest market, or may delay some purchasing to later markets. In some embodiments, the system may pay penalties for overpurchase. In some embodiments, the system may optimize these purchases using an approach known as Risk Limiting Dispatch. In such approaches, the system may utilize a purchase policy that optimizes the tradeoffs among power costs and penalties under various conditions and assumptions.

In some embodiments, the system may instead optimize green and brown power purchases using a process that is simpler algorithmically. Such an approach may use load predictions and ensure, in the day-ahead market, sufficient supply to meet hour-by-hour demand predictions for the next day. The system may further select resources that minimize the cost of this supply. As part of this optimization and purchase, the system may also make longer-term predictions, in order to consider using power resources having long start-up times.

However, in some embodiments using such an approach, the system need not consider models of the accuracy of its predictions, or tradeoffs between prices in the shorter-term markets and increased prediction accuracy in the shorter time frame. In the shorter-term markets (e.g., “real-time” markets), the system may balance supply with real-time demand. In these markets, the system may purchase different types of supply that are essentially “on-call,” to perform demand-following and regulation.

In some embodiments using such an approach, the system may purchase power in a respective market j, held at time t−dⱼ, based on the most recent available estimate of power consumption. That is, the system may make the total power purchased at any given time t−dⱼ equal to the currently-predicted power usage at time t. Note that in some embodiments, this may also include selling power in a given market (gⱼ and bⱼ can be negative), e.g. if the predicted usage reduces from the time of the previous market. In some embodiments, the system may do so making use of a simple algorithm, or variants thereof, representing this dispatch rule as: gⱼ(t|t−dⱼ)=Σᵢ\tilde{p}ᵢ(t|t−dⱼ)_{Q}_{ᵢ}−Σₖ₌₁^{j-1}gₖ(t|t−dₖ)=Σᵢ\tilde{p}ᵢ(t|t−dⱼ)_{Q}_{ᵢ}−Σᵢ\tilde{p}ᵢ(t|t−dⱼ₋₁)_{Q}_{ᵢ}. Here the second equality follows by induction. Likewise: bⱼ(t|t−dⱼ)=E(Σᵢ\tilde{p}ᵢ(t|t−dⱼ))−gⱼ(t|t−dⱼ)−Σₖ₌₁^{j-1} {gₖ(t|t−dₖ)+bₖ(t|t−dₖ)}=E(\tilde{p}(t|t−dⱼ))−g(t|t−dⱼ)−Σₖ₌₁^{j-1} {gₖ(t|t−dₖ)+bₖ(t|t−dₖ)}=E(\tilde{p}(t|t−dⱼ))−gⱼ(t|t−dⱼ)−E(\tilde{p}(t|t−dⱼ₋₁)), where the last equality again follows by induction.

In some embodiments, the different jobs i may not be independent, so the system may compute the expectation E (\tilde{p}(t|t−dⱼ)) separately from E (\tilde{p}ᵢ(t|t−dⱼ)). Note also that for jobs not participating in the green tiered plan, Q may be zero. Further, the system may not allow selling more power than was previously purchased (i.e., Σₖ₌₁^{j} gₖ≥0 and Σₖ₌₁^{j} bₖ≥0, for all j).

In some embodiments, instead of purchasing green power via an advance power market, the system may purchase green power via a price purchase agreement (PPA) or a commercial power agreement. This may involve predicting a total quantity of green power needed to satisfy the plurality of SLAs, including a level of green power specified by a respective SLA, during a future time interval. The system may estimate and allocate costs based on modeling these price structures.

For the case of the PPA, the system may commit in advance to buying a large amount G of green power over a period of time, which may be a long period. During this period, the system may meet additional power needs through standard commercial brown power or via a power market. The system may purchase a quantity p_{g}(t)=G of green power, which is at least as large as the predicted green power need Σᵢ\tilde{p}ᵢ(t)_{Q}_{ᵢ}. In some embodiments, G may be based on the maximum predicted green need over time, G=maxₜ Σᵢ \tilde{p}ᵢ(t)_{Q}_{ᵢ}. The total cost may be the cost C_{G} of the quantity G of green power over the time period, which may be fixed by the PPA, plus the cost of the brown power, which may depends on the purchase method (i.e., standard commercial power vs. electricity market) and any agreements. In some embodiments, the cost C_{G} may be proportional to the quantity G. In some embodiments, the PPA may be more complex. For example, the PPA might cover wind power, up to a maximum amount, with an understanding that supplementary green power may be purchased at times when the wind farm is unable to provide the full quantity G.

In some embodiments, the system may purchase green power via a commercial power agreement specifying a number of blocks of green power of a predetermined size. In some embodiments, the cost may be proportional to the number of blocks, or may be more complex, e.g. taking into account the source of the green power. The system may meet additional power needs during usage by purchasing commercial brown power. The system may then determine the number of blocks of green power to purchase by rounding up (i.e. applying a ceiling function) the predicted green power need Σᵢ \tilde{p}ᵢ(t)_{Q}_{ᵢ}, to the nearest increment of blocks.

As mentioned above, four important elements for accountability in the disclosed methods and system include modeling power markets and costs, dispatch (making power purchase decisions), scheduling and operation, and allocating costs to customers. In some embodiments, the system allocates the costs based on apportioning the power usage, which may include an overhead power usage, to jobs or to customers. To do so, the system may use a more sophisticated apportioning than simply assuming each job's (or customer's) overhead usage is proportional to its total usage. Instead, the system may apportion taking into account the jobs' power quality or responsiveness requirements. For example, in a data center, a faster response time may require more idle computers that can respond immediately when jobs appear, thereby contributing to the overhead power usage. Therefore, if certain jobs have SLAs with stronger responsiveness requirements than others, these jobs may be allocated a larger portion of the overhead power consumption.

In some embodiments, the system may apportion power among jobs based on a Shapley value. The Shapley value is a method for apportioning or allocating a shared profit or gain among players in a cooperative game, based on an estimate of the players' respective contributions. (Note that the system may represent the player as a customer or job, and the shared gain as the negative of cost or consumed power). The Shapley value apportions gain to a respective player based on marginal gains resulting from including the player, holding all else constant. The Shapley value for the payoff share for player i is:

$${ϕ}_{i} = {\sum }_{S ⊆ N \backslash \{ i \}} \frac{\vert S \vert ! \{ \vert N \vert - \vert S \vert - 1 ) !}{\vert N \vert !} [ v ( S ⋃ \{ i \} ) - v ( S ) ] ,$$

where v(S) is a value function specifying a gain for a subset S of the total set of players N. The system may apportion costs c or power usage p based on setting v=−p or v=−c in this formula.

Because the structure of the value function v is not necessarily convex, the Shapley value may not lie in the core for every problem. (Note that the core refers to the set of allocations that cannot be improved upon by any subset S of the players by changing strategy). Therefore, in some embodiments, the system uses a core-based method, or a game-theoretic method that provides a solution in the core, to apportion power consumption and/or costs. For example, the system may use a nucleolus method known in the art. By using such a core-based method, the system may guarantee that every subset of jobs is apportioned the same or less power usage and cost than it would receive on its own. That is, the system may guarantee that no subset of jobs subsidizes other jobs.

To apportion costs, the system may simply allocate costs among jobs in proportion to the allocated power use. However, doing so may fail to account for differing costs based on the type of power (brown vs. different types of green power) or other differences among SLAs. Therefore, the system may use the Shapley value, or a core-based method such as a nucleolus method to assign costs. Given a known cost structure for each power source (e.g., purchase methods for power markets, PPAs, or commercial power as described above), the system may calculate a Shapley value or core-based solution to assign costs to each customer.

### Exemplary Apparatus

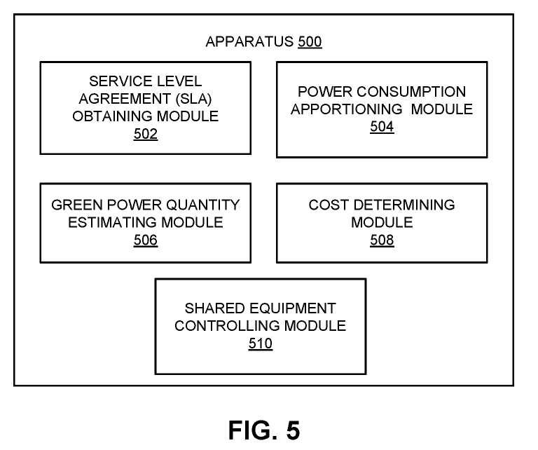

FIG. 5 presents a block diagram illustrating an exemplary apparatus for tiered greening of power consumption on shared equipment, in accordance with embodiments of the present invention. Apparatus 500 can comprise a plurality of modules which may communicate with one another via a wired or wireless communication channel. Apparatus 500 may be realized using one or more integrated circuits, and may include fewer or more modules than those shown in FIG. 5. Further, apparatus 500 may be integrated in a computer system, or realized as a separate device which is capable of communicating with other computer systems and/or devices. Specifically, apparatus 500 can comprise a Service Level Agreement (SLA) obtaining module 502, a power consumption apportioning module 504, a green power quantity estimating module 506, a cost determining module 508, and a shared equipment controlling module 510. Note that apparatus 500 may also include additional modules not depicted in FIG. 5.

In some embodiments, SLA obtaining module 502 can obtain an SLA between a provider and a customer, specifying a level of green power generated from renewable sources for a respective job, and green power quality and delivery requirements. Power consumption apportioning module 504 may apportion power consumption to a respective job, satisfying the respective job's SLA, including the level of green power specified by the respective job's SLA, and yielding a net increase in a total level of green power of the plurality of jobs. Green power quantity estimating module 506 may estimate a quantity of green power needed to satisfy the respective SLA. Cost determining module 508 may determine a cost associated with the estimated quantity of green power and with a quantity of other power. Shared equipment controlling module 510 may control shared equipment to execute the respective job according to the apportioned power consumption. Note that tiered greening module 202 illustrated in FIG. 2 may provide any and all functions of the various modules depicted in FIG. 5.

### Exemplary System

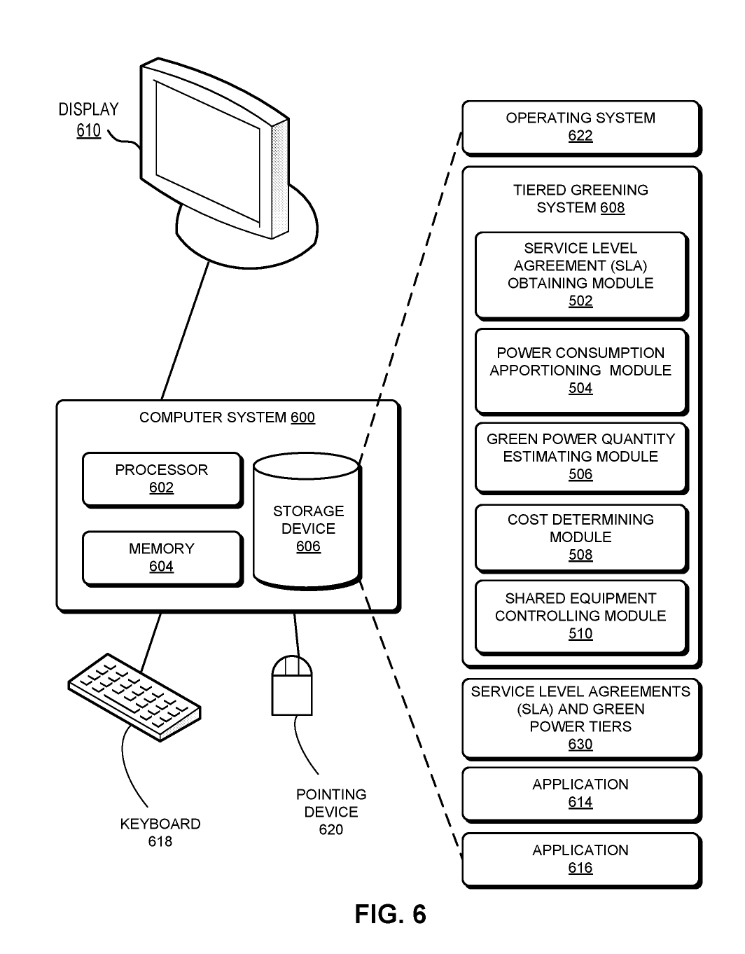

FIG. 6 presents a block diagram illustrating an exemplary computer system for tiered greening of power consumption on shared equipment, in accordance with embodiments of the present invention. In some embodiments, computer system 600 may be a server. In some embodiments, system 600 includes a processor 602, a memory 604, and a storage device 606. In some embodiments, 602 may include a set of processors. Storage device 606 may store a number of applications, such as applications 614 and 616, which may make use of tiered greening of power consumption according to embodiments of the present invention, and operating system 622. Storage device 606 also stores tiered greening system 608 that may include a Service Level Agreement (SLA) obtaining module 502, a power consumption apportioning module 504, a green power quantity estimating module 506, a cost determining module 508, and a shared equipment controlling module 510. System 600 and/or SLA obtaining module 502 may receive or generate SLAs and green power tiers 630 comprising green power quality and delivery requirements data and may copy green power quality and delivery requirements data to a memory section accessible to tiered greening system 608. During operation, one or more applications, such as tiered greening system 608, are loaded from storage device 606 into memory 604 and then executed by processor set 602. While executing the program, processor set 602 performs the aforementioned functions. System 600 may be coupled to a display 610, a keyboard 618, and a pointing device 620.

In some embodiments, SLA obtaining module 502 can obtain an SLA between a provider and a customer, specifying a level of green power generated from renewable sources for a respective job, and green power quality and delivery requirements. Power consumption apportioning module 504 may apportion power consumption to a respective job, satisfying the respective job's SLA, including the level of green power specified by the respective job's SLA, and yielding a net increase in a total level of green power of the plurality of jobs. Green power quantity estimating module 506 may estimate a quantity of green power needed to satisfy the respective SLA. Cost determining module 508 may determine a cost associated with the estimated quantity of green power and with a quantity of other power. Shared equipment controlling module 510 may control shared equipment to execute the respective job according to the apportioned power consumption. Note that tiered greening module 202 illustrated in FIG. 2 may provide any and all functions of the various modules depicted in FIG. 6.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for tiered greening of power consumption on shared equipment, comprising:
obtaining, by a computer system, a plurality of Service Level Agreements (SLAs) detailing power consumption by a plurality of jobs belonging to a plurality of customers, wherein a respective SLA specifies a level of green power generated from renewable sources for a respective job, and further specifies green power quality and delivery requirements;
apportioning, by the computer system, the power consumption to the respective job in the plurality of jobs, wherein the apportioned power consumption satisfies the respective SLA, including the level of green power, and yields a net increase in a total level of green power of the plurality of jobs; and
controlling the shared equipment to execute the respective job according to the apportioned power consumption.

2. The method of claim 1, wherein apportioning the power consumption to the respective job further comprises apportioning an overhead power consumption.

3. The method of claim 2, wherein apportioning the power consumption to the respective job further comprises:
estimating a total power consumption, including the overhead power consumption, needed to satisfy the plurality of SLAs, including a quality specification;
estimating a quantity of green power needed to satisfy the respective SLA, including the level of green power and the green power quality and delivery requirements; and
estimating, based on the total power consumption and the quantity of green power, a quantity of other power needed to execute the job in satisfaction of the respective SLA.

4. The method of claim 3, wherein apportioning the power consumption to the respective job further comprises:
determining a cost associated with the estimated quantity of green power and quantity of other power; and
associating the determined cost with a customer to whom the respective job belongs.

5. The method of claim 4, wherein determining the cost involves one or more of:
computing the cost as a Shapley value;
computing a core-based solution for the cost; and
applying a nucleolus method.

6. The method of claim 1, wherein apportioning the power consumption to the respective job further comprises:
predicting a total quantity of green power needed to satisfy the plurality of SLAs, including the level of green power, during a future time interval; and
purchasing green power, based on the predicted total quantity, via one or more of:
an advance power market;
a spot power market;
a price purchase agreement (PPA); and
a commercial power agreement specifying a number of blocks of green power of a predetermined size.

7. The method of claim 1, wherein the respective SLA specifies one or more of:
a proportion of green power to be used in the job;
a proportion of green power to be used over a time period in the job;
a quantity of green power to be used in the job;
a type of green power to be used in the job;
a source of green power to be used in the job;
a timing of green power to be used in the job;
a response time associated with the job; and
a speed associated with the job.

8. A non-transitory computer-readable storage medium storing instructions that when executed by a computer cause the computer to perform a method for tiered greening of power consumption on shared equipment, the method comprising:
obtaining, by a computer system, a plurality of Service Level Agreements (SLAs) detailing power consumption by a plurality of jobs belonging to a plurality of customers, wherein a respective SLA specifies a level of green power generated from renewable sources for a respective job, and further specifies green power quality and delivery requirements;
apportioning, by the computer system, the power consumption to the respective job in the plurality of jobs, wherein the apportioned power consumption satisfies the respective SLA, including the level of green power, and yields a net increase in a total level of green power of the plurality of jobs; and
controlling the shared equipment to execute the respective job according to the apportioned power consumption.

9. The non-transitory computer-readable storage medium of claim 8, wherein apportioning the power consumption to the respective job further comprises apportioning an overhead power consumption.

10. The non-transitory computer-readable storage medium of claim 9, wherein apportioning the power consumption to the respective job further comprises:
estimating a total power consumption, including the overhead power consumption, needed to satisfy the plurality of SLAs, including a quality specification;
estimating a quantity of green power needed to satisfy the respective SLA, including the level of green power and the green power quality and delivery requirements; and
estimating, based on the total power consumption and the quantity of green power, a quantity of other power needed to execute the job in satisfaction of the respective SLA.

11. The non-transitory computer-readable storage medium of claim 10, wherein apportioning the power consumption to the respective job further comprises:
determining a cost associated with the estimated quantity of green power and quantity of other power; and
associating the determined cost with a customer to whom the respective job belongs.

12. The non-transitory computer-readable storage medium of claim 11, wherein determining the cost involves one or more of:
computing the cost as a Shapley value;
computing a core-based solution for the cost; and
applying a nucleolus method.

13. The non-transitory computer-readable storage medium of claim 8, wherein apportioning the power consumption to the respective job further comprises:
predicting a total quantity of green power needed to satisfy the plurality of SLAs, including the level of green power, during a future time interval; and
purchasing green power, based on the predicted total quantity, via one or more of:
an advance power market;
a spot power market;
a price purchase agreement (PPA); and
a commercial power agreement specifying a number of blocks of green power of a predetermined size.

14. The non-transitory computer-readable storage medium of claim 8, wherein the respective SLA specifies one or more of:
a proportion of green power to be used in the job;
a proportion of green power to be used over a time period in the job;
a quantity of green power to be used in the job;
a type of green power to be used in the job;
a source of green power to be used in the job;
a timing of green power to be used in the job;
a response time associated with the job; and
a speed associated with the job.

15. A computing system for tiered greening of power consumption on shared equipment, the system comprising:
a set of processors; and
a non-transitory computer-readable medium coupled to the set of processors storing instructions thereon that, when executed by the processors, cause the processors to perform a method for tiered greening of power consumption on shared equipment, the method comprising:
obtaining, by a computer system, a plurality of Service Level Agreements (SLAs) detailing power consumption by a plurality of jobs belonging to a plurality of customers, wherein a respective SLA specifies a level of green power generated from renewable sources for a respective job, and further specifies green power quality and delivery requirements;
apportioning, by the computer system, the power consumption to the respective job in the plurality of jobs, wherein the apportioned power consumption satisfies the respective SLA, including the level of green power, and yields a net increase in a total level of green power of the plurality of jobs; and
controlling the shared equipment to execute the respective job according to the apportioned power consumption.

16. The computing system of claim 15, wherein apportioning the power consumption to the respective job further comprises apportioning an overhead power consumption.

17. The computing system of claim 16, wherein apportioning the power consumption to the respective job further comprises:
estimating a total power consumption, including the overhead power consumption, needed to satisfy the plurality of SLAs, including a quality specification;
estimating a quantity of green power needed to satisfy the respective SLA, including the level of green power and the green power quality and delivery requirements; and
estimating, based on the total power consumption and the quantity of green power, a quantity of other power needed to execute the job in satisfaction of the respective SLA.

18. The method of claim 17, wherein apportioning the power consumption to the respective job further comprises:
determining a cost associated with the estimated quantity of green power and quantity of other power; and
associating the determined cost with a customer to whom the respective job belongs.

19. The computing system of claim 18, wherein determining the cost involves one or more of:
computing the cost as a Shapley value;
computing a core-based solution for the cost; and
applying a nucleolus method.

20. The computing system of claim 15, wherein apportioning the power consumption to the respective job further comprises:
predicting a total quantity of green power needed to satisfy the plurality of SLAs, including the level of green power, during a future time interval; and
purchasing green power, based on the predicted total quantity, via one or more of:
an advance power market;
a spot power market;
a price purchase agreement (PPA); and
a commercial power agreement specifying a number of blocks of green power of a predetermined size.
